(19) United States
(12) Patent Application Publication
(10) Pub. No.: US 2022/0221843 A1
(43) Pub. Date: Jul. 14, 2022

(54) ANOMALY DETECTION IN HIGH-VOLUME MANUFACTURING LINES

(71) Applicant: VANTI ANALYTICS LTD., Tel Aviv (IL)

(72) Inventors: Nir OSIROFF, Ganei Tikva (IL); Smadar DAVID RALY, Ramat Gan (IL)

(73) Assignee: VANTI ANALYTICS LTD, Tel Aviv (IL)

(21) Appl. No.: 17/567,988

(22) Filed: Jan. 4, 2022

Related U.S. Application Data
(60) Provisional application No. 63/135,770, filed on Jan. 11, 2021.
(60) Provisional application No. 63/183,080, filed on May 3, 2021.

(51) Int. Cl. G05B 19/418

(52) U.S. Cl. CPC G05B 19/4184; G05B 19/4188; G05B 19/4183; G05B 19/41845

(57) ABSTRACT

Systems and methods are provided for improving a high-volume manufacturing (HVM) line that has a test pass ratio of at least 90%, by constructing a genetic neural architecture search (GNAS) network that detects anomalies in the HVM line at a detection rate of at least 85%. Disclosed systems and methods combine data balancing of the highly skewed raw data with a network construction that is based on building blocks that reflect technical knowledge related to the HVM line. The GNAS network construction is made thereby both simpler and manageable and provides meaningful insights for improving the production process.

### CROSS REFERENCE TO RELATED APPLICATIONS

This application claims the benefit of U.S. Provisional Application No. 63/135,770, filed Jan. 11, 2021 and U.S. Provisional Application No. 63/183,080, filed May 3, 2021, which are hereby incorporated by reference.

### BACKGROUND OF THE INVENTION

### 1. Technical Field

The present invention relates to the field of machine learning, and more particularly, to anomaly detection at production lines with a high test-pass ratio and estimation of model performance.

### 2. Discussion of Related Art

High-volume manufacturing (HVM) lines, operated, e.g., in electronics manufacturing, typically have very high test-passing rates, of 90%, 95% or more, which make it difficult to provide additional improvements and also very challenging with respect to the ability to provide improvements such as reliable early fault detection. However, as HVM lines are very costly, any additional improvement can provide marked benefits in terms of efficiency and production costs.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a system for improving a high-volume manufacturing (HVM) line that has a test pass ratio of at least 90%, the system comprising: a data engineering module configured to receive raw data from the HVM line and derive process variables therefrom, a data balancing module configured to generate balanced data from the raw data received by the data engineering module, and an anomaly detection module comprising a GNAS (genetic neural architecture search) network comprising an input layer including the balanced data generated by the data balancing module and a plurality of interconnected layers, wherein each interconnected layer comprises: a plurality of blocks, wherein each block comprises a model that applies specified operations to input from the previous layer in relation to the derived process variables—to provide an output to the consecutive layer and a fitness estimator of the model, a selector sub-module configured to compare the models of the blocks using the respective fitness estimators, and a mutator sub-module configured to derive an operation probability function relating to the operations and a model probability function relating to the models—which are provided as input to the consecutive layer; wherein the model outputs, the operation probability function and the model probability function provided by the last of the interconnected layers are used to detect anomalies in the HVM line at a detection rate of at least 85%.

One aspect of the present invention provides a method of improving a high-volume manufacturing (HVM) line that has a test pass ratio of at least 90%, the method comprising: receiving raw data from the HVM line and deriving process variables therefrom, generating balanced data from the received raw data, and detecting anomalies relating to the HVM line by constructing a GNAS (genetic neural architecture search) network that includes an input layer including the generated balanced data and a plurality of interconnected layers, wherein the constructing of the GNAS network comprises: arranging a plurality of blocks for each interconnected layer, wherein each block comprises a model that applies specified operations to input from the previous layer in relation to the derived process variables—to provide an output to the consecutive layer and a fitness estimator of the model, comparing the models of the blocks using the respective fitness estimators, and deriving an operation probability function relating to the operations and a model probability function relating to the models by mutating the blocks and the structure of the layers, and providing the model outputs, the operation probability function and the model probability function as input to the consecutive layer; wherein the model outputs, the operation probability function and the model probability function provided by the last of the interconnected layers are used to detect anomalies in the HVM line at a detection rate of at least 85%.

One aspect of the present invention provides a method of assessing robustness and performance of an early fault detection machine learning (EFD ML) model for an electronics' production line, the method comprising: constructing a learning curve from a received amount of data from the electronics' production line, the learning curve representing a relation between a performance of the EFD ML model and a sample size of the data on which the EFD ML model is based, and deriving from the learning curve an estimation of model robustness by (i) fitting the learning curve to a power law function and (ii) estimating a tightness of the fitting.

One aspect of the present invention provides a method of assessing robustness and performance of an early fault detection machine learning (EFD ML) model for an electronics' production line, the method comprising: constructing a learning curve from a received amount of data from the electronics' production line, the learning curve representing a relation between a performance of the EFD ML model and a sample size of the data on which the EFD ML model is based, and deriving from the learning curve an estimation of model robustness by applying a machine learning algorithm that is trained on a given plurality of learning curves and related normalized performance values.

One aspect of the present invention provides a system for improving a high-volume manufacturing (HVM) line, the system comprising: a data engineering module configured to receive raw data from the HVM line and derive process variables therefrom, a data balancing module configured to generate balanced data from the raw data received by the data engineering module, an anomaly detection module configured to use the generated balanced data to detect anomalies in the HVM line at a detection rate of at least 85%—using an early fault detection machine learning (EFD ML) model, and a model assessment module configured to assess robustness and performance of the EFD ML model by constructing a learning curve from a received amount of data from the HVM line, the learning curve representing a relation between a performance of the EFD ML model and a sample size of the data on which the EFD ML model is based, and deriving from the learning curve an estimation of model robustness by (i) fitting the learning curve to a power law function and (ii) estimating a tightness of the fitting.

One aspect of the present invention provides a system for improving a high-volume manufacturing (HVM) line, the system comprising: a data engineering module configured to receive raw data from the HVM line and derive process variables therefrom, a data balancing module configured to generate balanced data from the raw data received by the data engineering module, an anomaly detection module configured to use the generated balanced data to detect anomalies in the HVM line at a detection rate of at least 85%—using an early fault detection machine learning (EFD ML) model, and a model assessment module configured to assess robustness and performance of the EFD ML model by constructing a learning curve from a received amount of data from the electronics' production line, the learning curve representing a relation between a performance of the EFD ML model and a sample size of the data on which the EFD ML model is based, and deriving from the learning curve an estimation of model robustness by applying a machine learning algorithm that is trained on a given plurality of learning curves and related normalized performance values.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIGS. 1A-1C are high-level schematic block diagrams of systems for improving a high-volume manufacturing (HVM) line that has a test pass ratio of at least 90%, according to some embodiments of the invention.

FIG. 1D is a schematic example for the improvement achieved by repeated application of disclosed systems, according to some embodiments of the invention.

FIGS. 2A and 2B provide schematic illustrations of the construction and optimization of the network of anomaly detection modules, according to some embodiments of the invention.

FIG. 3A is a high-level flowchart illustrating methods, according to some embodiments of the invention.

FIG. 3B is a high-level block diagram of an exemplary computing device, which may be used with embodiments of the present invention.

FIG. 4 illustrates schematically results of a proof-of-concept experiment using real data provided as raw data to several machine learning platforms.

FIG. 5A is a high-level schematic block diagram of a system, according to some embodiments of the invention.

FIG. 5B illustrates in a high-level schematic manner some of the challenges involved in constructing an EFD ML model, as known in the art.

FIG. 6 is a high-level flowchart illustrating methods of assessing robustness and performance of early fault detection machine learning (EFD ML) models for an electronics' production line, according to some embodiments of the invention.

FIGS. 7A and 7B provide a non-limiting example of a learning curve, according to some embodiments of the invention.

FIGS. 8A and 8B provide a non-limiting example of a learning curve for a fully trained robust model, according to some embodiments of the invention.

FIGS. 9A and 9B provide a non-limiting example of a learning curve for a fully trained deteriorating model, according to some embodiments of the invention.

FIGS. 10A, 10B and 10C provides a non-limiting example of a learning curve for a model with a high learning capacity, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing”, “deriving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

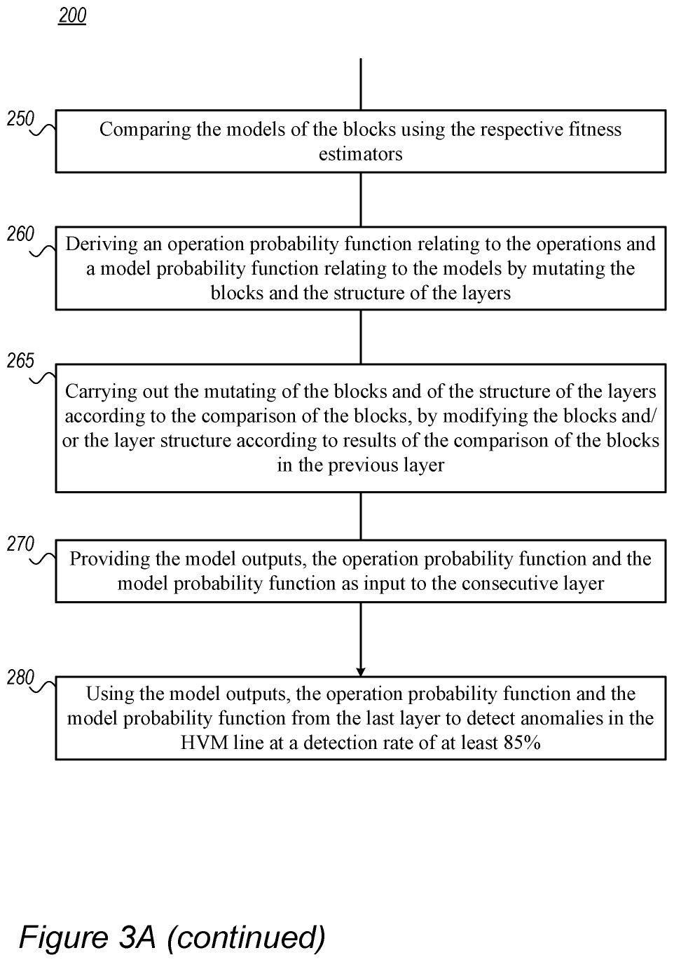

Embodiments of the present invention provide efficient and economical methods and mechanisms for improving the efficiency of high-volume manufacturing (HVM) lines. It is noted that as HVM lines typically have yield ratios larger than 90% (over 90% of the products pass the required quality criteria), the pass/fail ratio is high and the data relating to products present high imbalance (having many pass data, few fail data)—which is a challenging case for machine learning and classification algorithms. Disclosed systems and methods reduce the fail rate even further, increasing the efficiency of the HVM line even further. To achieve this, the required model accuracy is larger than 85%, to ensure positive overall contribution of disclosed systems and methods to the efficiency of the HVM line (see also FIG. 4 below).

Disclosed systems and methods construct a genetic neural architecture search (GNAS) network that detects anomalies in the HVM line at a detection rate of at least 85%—by combining data balancing of the highly skewed raw data with a network construction that is based on building blocks that reflect technical knowledge related to the HVM line. The GNAS network construction is made thereby both simpler and manageable and provides meaningful insights for improving the production process.

Knowledge of the production process is used in the construction the elements and the structure of the network model as described below, providing constraints within the general framework of NAS (neural architecture search) that allow achieving high accuracy together with relatively low complexity and training time. It is noted that in contrast to traditional neural networks, in which the machine learning algorithms are trained to adjust the weights assigned to nodes in the network, the NAS approach also applies algorithms to modify the network structure itself. However, resulting algorithms are typically complex and resource intensive due to the large number of degrees of freedom to be trained. Innovatively, disclosed systems and methods utilize the knowledge of the production process to simultaneously provide effective case-specific anomaly detection and to simplify the NAS training process by a factor of 10²-10³ in terms of training time and required data.

Embodiments of the present invention provide efficient and economical systems and methods for improving a high-volume manufacturing (HVM) line by assessing robustness and performance of an early fault detection machine learning (EFD ML) models. Learning curve(s) may be constructed from a received amount of data from the electronics' production line, the learning curve representing a relation between a performance of the EFD ML model and a sample size of the data on which the EFD ML model is based. Learning curve(s) may be used to derive estimation(s) of model robustness by (i) fitting the learning curve to a power law function and (ii) estimating a tightness of the fitting and/or by applying a machine learning algorithm that is trained on a given plurality of learning curves and related normalized performance values.

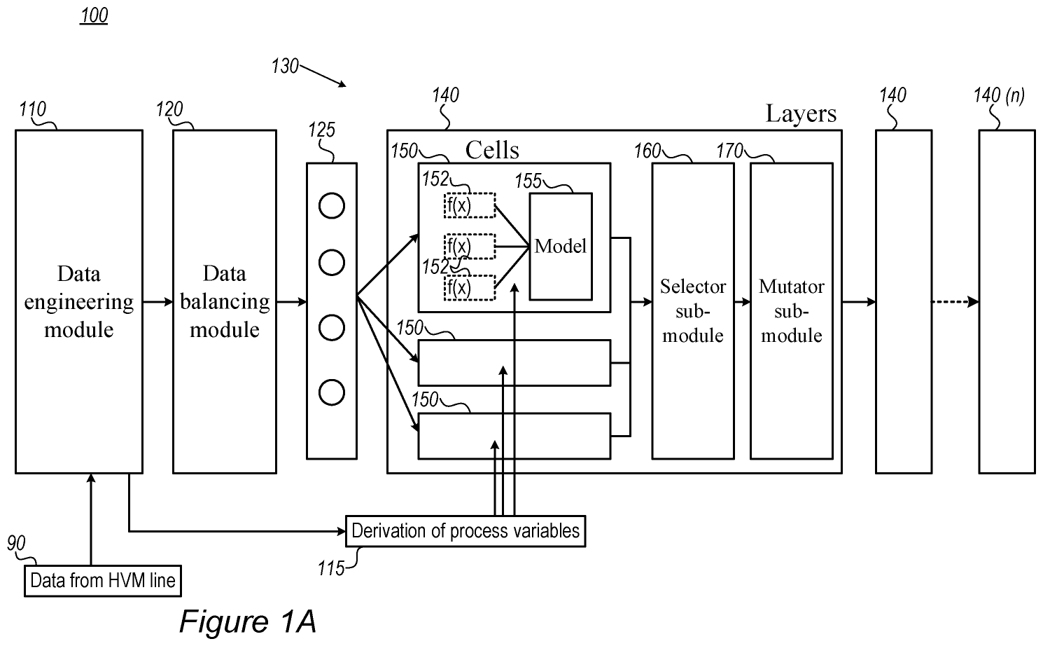

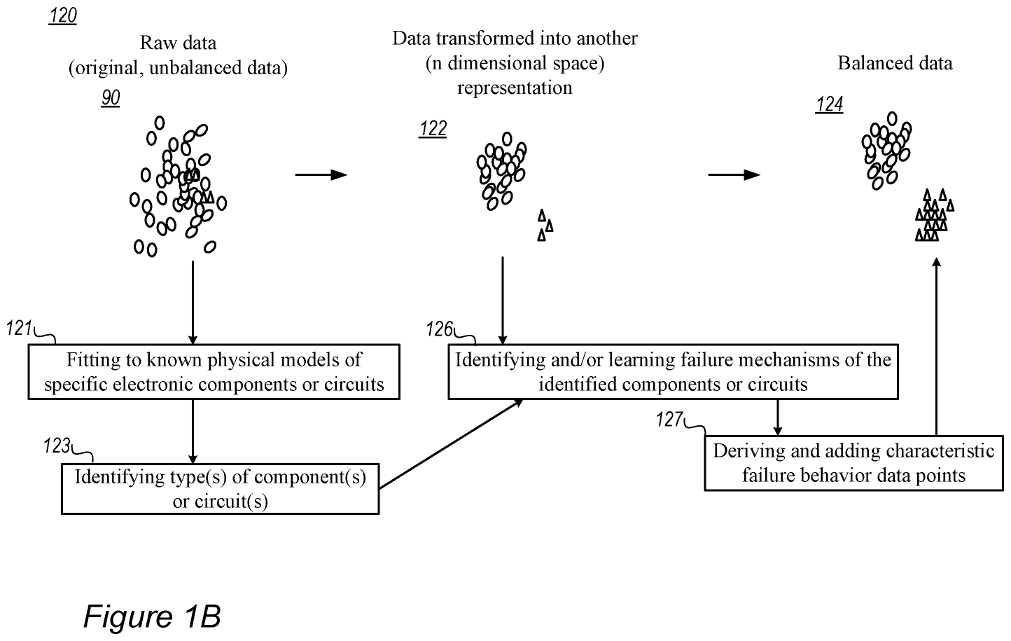

FIGS. 1A-1C are high-level schematic block diagrams of a system 100 for improving a high-volume manufacturing (HVM) line that has a test pass ratio of at least 90%, according to some embodiments of the invention. FIG. 1A is an overview illustration of system 100, FIG. 1B provides details concerning data balancing in data balancer 120 of system 100 and FIG. 1C provides details concerning blocks 150 and layers 140, as explained below.

System 100 comprises a data engineering module 110 configured to receive raw data 90 from the HVM line and derive process variables 115 therefrom, a data balancing module 120 configured to generate balanced data 124 from raw data 90 received by data engineering module 110, and an anomaly detection module 130 comprising a GNAS (genetic neural architecture search) network comprising an input layer 125 including balanced data 124 generated by data balancing module 120 and a plurality of interconnected layers 140 (e.g., n layers).

Raw data 90 may comprise any data relevant to the production processes such as data and measurements relating to the produced circuits and components used therein. For example, raw data 90 may comprise design and components data, test results concerning various produced circuits at various conditions (e.g., heating), measurements of various components (e.g., resistance under various conditions), performance requirements at different level, optical inspection results, data relating to the production machinery during the production (and/or before or after production), data related to previously produced batches, etc. Specifically, raw data 90 may comprise time series measurements of temperature, humidity and/or other environmental factors, time series measurements of deposition, etching or any other process applied to any one of the layers of the device or circuit being produced, time series measurements of physical aspects of components such as thickness, weight, flatness, reflectiveness, etc., and so forth. Process variables 115 derived from raw data 90 may comprise performance measures and characteristics, possibly based on physical models or approximations relating to the production processes. The derivation of process variables 115 may be carried out by combining and recombining computational building blocks derived from analysis of raw data 90 and/or from analysis of corresponding data received in other projects and/or from analysis related to the production processes.

Data engineering module 110 may provide the algorithmic front end of system 100 and may be configured to handle missing or invalid values in received raw data 90, handle errors associated with raw data 90, apply knowledge-based adjustments to raw data 90 to derive values that are better suited for training the network of anomaly detection module 130, and/or impute raw data 90 by substituting or adding data. For example, data engineering module 110 may comprise a data validity sub-module configured to confirm data validity and if needed correct data errors and a data imputer sub-module configured to complete or complement missing data.

Data may be validated with respect to an analysis of raw data 90 and/or from analysis of corresponding data received in other projects and/or from analysis related to the production processes. Data imputations may be carried out using similar analysis, and may comprise, e.g., filling in average or median values, or predicting missing data based on analysis of raw data 90, e.g., using localized predictors or models, and/or from analysis of corresponding data received in other projects and/or from analysis related to the production processes, such as industry standards.

For example, data adjustments carried out by data engineering module 110 may comprise any of the following non-limiting examples: (i) Imputation of missing data based on prior understanding of common operating mechanisms. The operating mechanisms may be derived and/or simulated, and relate to electronic components and circuits that are being manufactures, as well as to manufacturing processes. (ii) Filtering of isolated anomalies that are errors in measurements and do not represent information that is helpful to the model building process, e.g., removing samples that are outliers. (iii) Nonlinear quantization of variables with high dynamic ranges to better represent ranges that are important for further analysis. Modification of values may be used to enhance the model performance and/or to enhance data balancing. (iv) Reclassification of datatypes (e.g., strings, numbers, Boolean variables) based on prior understanding of the correct appropriate value. For example, measurement of physical parameters such as current, temperature or resistance may be converted to number format, e.g., if it is recorded in a different format such as string or coded values—to enhance model accuracy.

In certain embodiments, data engineering module 110 may comprise a hybrid of rule-based decision making and shallow feature generation networks, e.g., using the approach of the region proposal phase of fast R-CNN (region-proposal-based convolution neural networks) or faster R-CNN.

Data balancing module 120 may balance processed raw data 90 (following processing by data engineering module 110) by translating the severely imbalanced data (e.g., 90%, 95% or even higher pass rates) to an equivalent data set where the target variable's distribution is more balanced, e.g., about 50% (or possible between 40-60%, between 30-70% or around intermediate values that yield more efficient classification). For example, data balancing module 120 may comprise a neural-network-based resampling sub-module configured to balance raw data 90. In a schematic illustrative example, see, e.g., FIG. 1B, raw (or initially processed) n-dimensional data 90 may be transformed into an alternative n-dimensional space, with the transformed data set 122 enabling better separation of the imbalanced data (e.g., pass and fail data). Balanced data 124 may then be generated by enhancing the representation of under-represented data (e.g., fail data) to reach the more balanced equivalent data set 124.

For example, raw data 90 may be used to identify specific electronic components or circuits (stage 123), e.g., by fitting data 90 or part(s) thereof to known physical models of components or circuits (stage 121), such as resistors, diodes, transistors, capacitors, circuits implementing logical gates etc. Data transformation 122 may be based on the identification of the specific electronic components or circuits. Raw data 90 and/or transformed data 122 may be used to identify and/or learn failure mechanisms of the identified components or circuits (stage 126), represented, e.g., by correlations in the data or deviations of the data from expected performance parameters according to known physical models. The identified failure mechanisms may then be used to derive and add data points corresponding to the characteristic failure behavior of the identified components or circuits (stage 127) to yield balanced data 124, having a more balanced fail to pass ratio (better than the 90-95% ratio for raw data 90, e.g., 50%, 40-60%, 30-70% or intermediate values). In some embodiments, more data may be added, e.g., not only failure data but also intermediate data.

Referring to FIG. 1C, interconnected layers 140 may comprise a plurality of blocks 150, wherein each block 150 comprises a model 155 that applies specified operations 152 (indicated schematically as f(x) in FIG. 1A) to input 151 from the previous layer (input layer 125 or previous layer 140) in relation to the derived process variables 115—to provide an output 156 to the consecutive layer 140 and a fitness estimator 157 of model 155. Blocks 150 are the basic units of the network used by anomaly detection module 130 and provide the representation of HVM line-related knowledge within the network. Advantageously with respect to regular NAS models, this incorporation of HVM line knowledge and layer structure reduce the complexity of constructing and training the NAS and enhance the explainability of the networks results. The basic structure of blocks 150 includes a fully connected input layer (layer 125 for first layer 140, and previous layer 140 for consecutive layers 140), onto which operator functions 152 are applied, e.g., one operation per input, such as, e.g., the identity operation or various functional operations such as polynomials, exponents, logarithms, sigmoid functions, trigonometric functions, rounding operations, quantization operations, compression operations, etc.

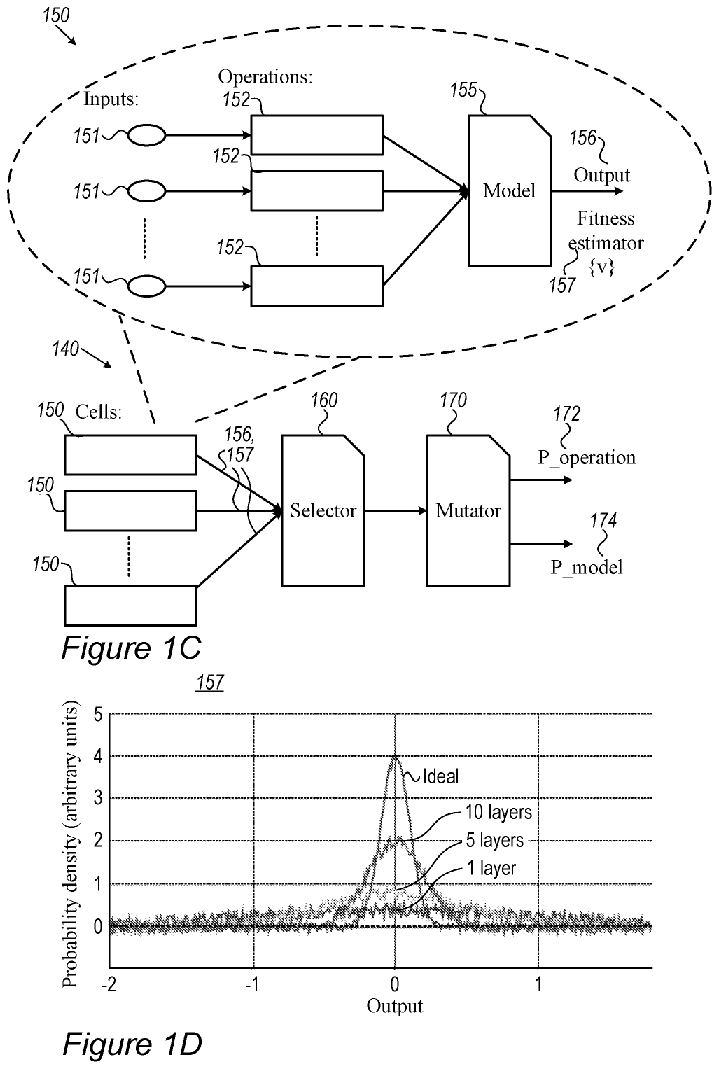

It is noted that layers 140 may be constructive consecutively, starting from an initial layer (which may be assembled from multiple similar or different blocks 150, randomly or according to specified criteria) and stepwise constructive additional layers that enhance blocks 150 and connections therebetween which have higher performance, e.g., as quantified by a fitness estimator 157 and/or by operations and model probability functions 172, 174 discussed below. Typically, performance is gradually increased with advancing layer construction. For example, as illustrated schematically in FIG. 1D, gradual improvement is achieved by repeated application of disclosed systems, according to some embodiments of the invention. In the example, the probability density for fitness estimator function 157 is illustrated for using one, five and ten layers 140, and compared with a representation of the ideal distribution with respect to a goal output value (illustrated in a non-limiting manner as zero). Gradual performance improvement is achieved as the iterative process described above refines blocks 150 and layers 140, as further illustrated below (see, e.g., FIGS. 2A and 2B).

Model 155 may then be applied on all operator outputs and be trained and evaluated to provide output 156 as well as, e.g., a vector of fitness scores as fitness estimator 157 that indicates the model performance, e.g., as a cost function. Non-limiting examples for types of model 155 include any of random forest, logistic regression, support vector machine (SVM), k-nearest neighbors (KNN) and combinations thereof.

Interconnected layers 140 further comprise a selector sub-module 160 configured to compare models 155 of blocks 150 using the respective fitness estimators 157, and a mutator sub-module 170 configured to derive an operation probability function 172 relating to operations 152 and a model probability function 174 relating to models 155—which are provided as input to the consecutive layer 140. Selector sub-module 160 may be configured to select best models 155 based on their respective fitness estimators 157, while mutator sub-module 170 may be configured to generate operation probability function 172 and model probability function 174 which may be used by consecutive layer 140 to adjust operator functions 152 and model 155, respectively, as well as to generate and add new options to the entirety of operator functions 152 and models 155 used and applied by anomaly detection module 130. Moreover, mutator sub-module 170 may be further configured to modify blocks 150 and/or the structure of layer 140 according to results of the comparison of blocks 150 in the previous layer 140 by selector sub-module 160.

Following the consecutive construction of layers 140, predictive multi-layered anomaly detection model 130 may be constructed from all, most, or some of layers 140, fine-tuning the selection process iteratively and providing sufficient degrees of freedom (variables) for the optimization of model 130 by the machine learning algorithms.

In certain embodiments, disclosed systems 100 and methods 200 are designed to minimize complexity and training time using cost function(s) that penalize the number of layers 140, the number of connections within and among layers 140 and/or the number of process variables 115 and other system parameters.

Referring to anomaly detection module 130 as a whole, model outputs 156, operation probability function 172 and model probability function 174 provided by the last of interconnected layers 140 may be used to detect anomalies in the HVM line at a detection rate of at least 85%.

FIGS. 2A and 2B provide schematic illustrations of the construction and optimization of the network of anomaly detection module 130, according to some embodiments of the invention. Raw data 90 and/or knowledge concerning HVM lines may be used to define different network elements or node types 115 that relate to the production process characteristics (corresponding to process variables 115). These derived elements 115 may then be arranged (step 117) as blocks 150 of various types (illustrated schematically in FIG. 2B) within a network layer 140 and the predictive performance of the layer may be evaluated 160 (e.g., by selector sub-module 160. Following the evaluation, improved layers 140 may be generated iteratively (step 180) by rearrangement and multiplications of the defined network elements or node types 115—resulting in consecutive layers 140 having different arrangements of blocks 150 and gradually improving performance. The layer modifications may be carried out by mutator sub-module 170. This process is illustrated schematically in FIG. 2B. Specifically, the evaluation of the results from each layer 140 may be used to identify specific operations 152 in, e.g., some of blocks 150 and apply these operations to same or other blocks 150 in next layer 140, to modify blocks 150 and/or the layer structure. These modifications are illustrated schematically in FIG. 2B by lines added to the basic schematic block illustrations. Step by step, disclosed systems 100 and methods 200 construct modified blocks 150 and modified layer structures to optimize the results and the network structure—using data and results derived from or related to the real manufacturing process—resulting in simpler and more effective networks than generic NNs.

Following the stepwise layer derivation, multiple layers 140 may be combined (step 180) to form the predictive multi-layered model for anomaly detection 130, using outputs 156 of blocks 150 and probability functions 172, 174.

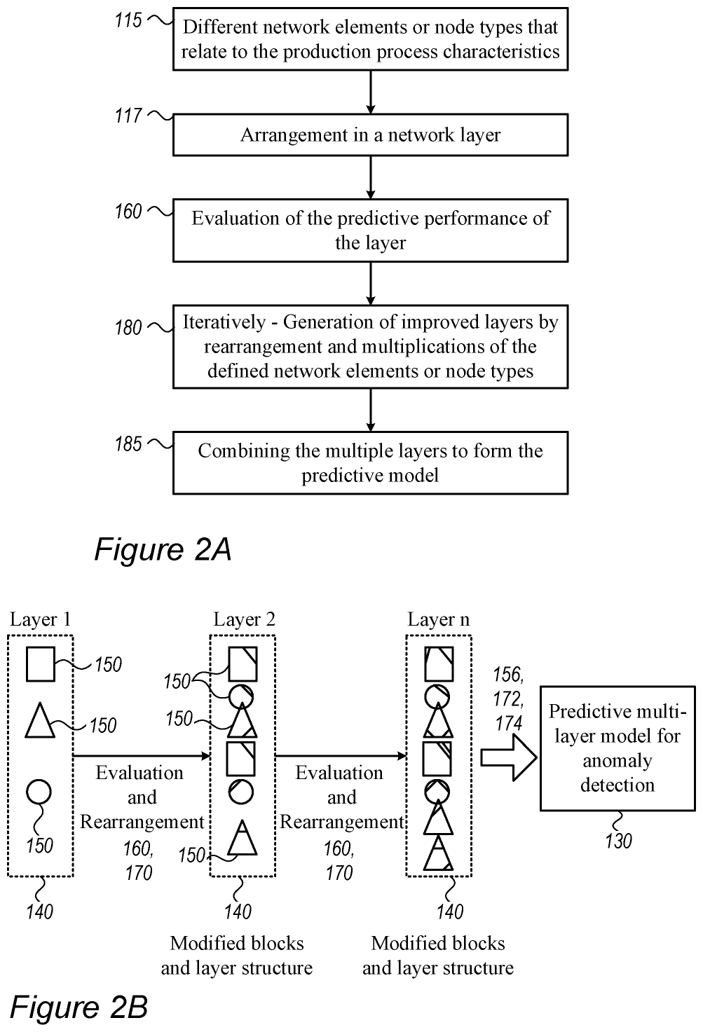

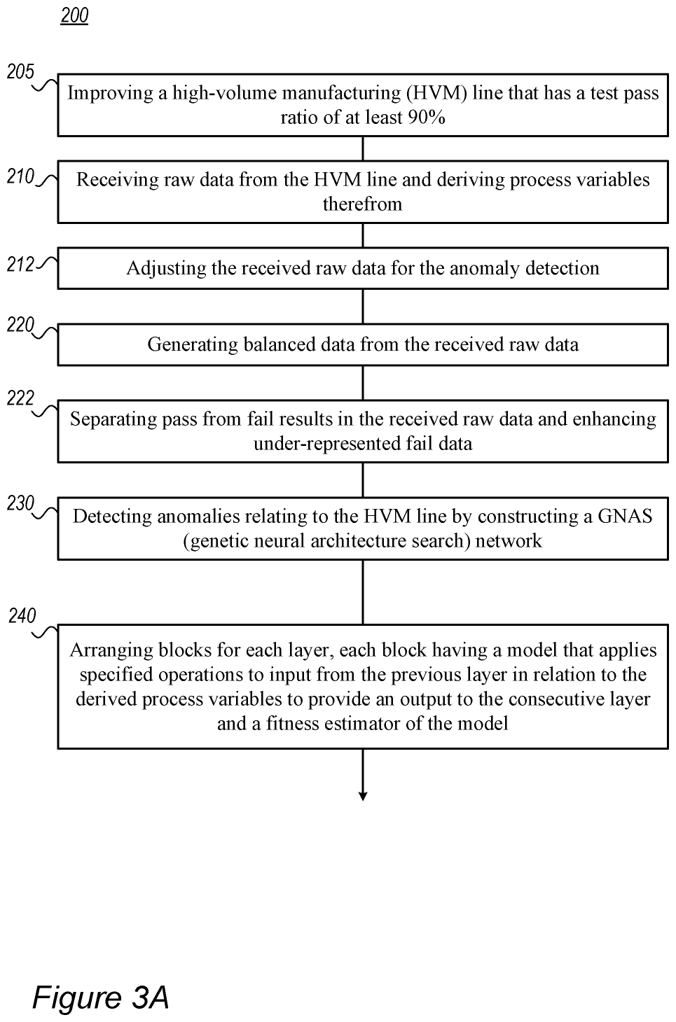

FIG. 3A is a high-level flowchart illustrating a method 200, according to some embodiments of the invention. The method stages may be carried out with respect to system 100 described above, which may optionally be configured to implement method 200. Method 200 may be at least partially implemented by at least one computer processor, e.g., in a module that is integrated in a HVM line. Certain embodiments comprise computer program products comprising a computer readable storage medium having computer readable program embodied therewith and configured to carried out the relevant stages of method 200. Method 200 may comprise the following stages, irrespective of their order.

Methods 200 comprise improving a high-volume manufacturing (HVM) line that has a test pass ratio of at least 90% (stage 205). Methods 200 comprise receiving raw data from the HVM line and deriving process variables therefrom (stage 210), optionally adjusting the received raw data for the anomaly detection (stage 212), generating balanced data from the received raw data (stage 220), e.g., by separating pass from fail results in the received raw data and enhancing under-represented fail data (stage 222), and detecting anomalies relating to the HVM line by constructing a GNAS (genetic neural architecture search) network that includes an input layer including the generated balanced data and a plurality of interconnected layers (stage 230).

In various embodiments, constructing of the GNAS network comprises arranging a plurality of blocks for each interconnected layer, wherein each block comprises a model that applies specified operations to input from the previous layer in relation to the derived process variables—to provide an output to the consecutive layer and a fitness estimator of the model (stage 240). Consecutively, method 200 comprises comparing the models of the blocks using the respective fitness estimators (stage 250), deriving an operation probability function relating to the operations and a model probability function relating to the models by mutating the blocks and the structure of the layers (stage 260), and providing the model outputs, the operation probability function and the model probability function as input to the consecutive layer (stage 270). In certain embodiments, the mutating of the blocks and of the structure of the layers according to the comparison of the blocks may be carried out by modifying the blocks and/or the layer structure according to results of the comparison of the blocks in the previous layer (stage 265). Finally, method 200 comprises using the model outputs, the operation probability function and the model probability function provided by the last of the interconnected layers to detect anomalies in the HVM line at a detection rate of at least 85% (stage 280).

FIG. 3B is a high-level block diagram of an exemplary computing device 101, which may be used with embodiments of the present invention, such as any of disclosed systems 100 or parts thereof, and/or methods 200 and/or 300, or steps thereof. Computing device 101 may include a controller or processor 193 that may be or include, for example, one or more central processing unit processor(s) (CPU), one or more Graphics Processing Unit(s) (GPU or general-purpose GPU—GPGPU), a chip or any suitable computing or computational device, an operating system 191, a memory 192, a storage 195, input devices 196 and output devices 197. Any of systems 100, its modules, e.g., data engineering module 110, data balancing module 120, anomaly detection module 130, model assessment module 135 and/or parts thereof may be or include a computer system as shown for example in FIG. 3B.

Operating system 191 may be or may include any code segment designed and/or configured to perform tasks involving coordination, scheduling, arbitration, supervising, controlling, or otherwise managing operation of computing device 101, for example, scheduling execution of programs. Memory 192 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory 192 may be or may include a plurality of possibly different memory units. Memory 192 may store for example, instructions to carry out a method (e.g., code 194), and/or data such as user responses, interruptions, etc.

Executable code 194 may be any executable code, e.g., an application, a program, a process, task or script. Executable code 194 may be executed by controller 193 possibly under control of operating system 191. For example, executable code 194 may when executed cause the production or compilation of computer code, or application execution such as VR execution or inference, according to embodiments of the present invention. Executable code 194 may be code produced by methods described herein. For the various modules and functions described herein, one or more computing devices 101 or components of computing device 101 may be used. Devices that include components similar or different to those included in computing device 101 may be used and may be connected to a network and used as a system. One or more processor(s) 193 may be configured to carry out embodiments of the present invention by for example executing software or code.

Storage 195 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data such as instructions, code, VR model data, parameters, etc. may be stored in a storage 195 and may be loaded from storage 195 into a memory 192 where it may be processed by controller 193. In some embodiments, some of the components shown in FIG. 3B may be omitted.

Input devices 196 may be or may include for example a mouse, a keyboard, a touch screen or pad or any suitable input device. It will be recognized that any suitable number of input devices may be operatively connected to computing device 101 as shown by block 196. Output devices 197 may include one or more displays, speakers and/or any other suitable output devices. It will be recognized that any suitable number of output devices may be operatively connected to computing device 101 as shown by block 197. Any applicable input/output (I/O) devices may be connected to computing device 101, for example, a wired or wireless network interface card (NIC), a modem, printer or facsimile machine, a universal serial bus (USB) device or external hard drive may be included in input devices 196 and/or output devices 197.

Embodiments of the invention may include one or more article(s) (e.g., memory 192 or storage 195) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

FIG. 4 illustrates schematically results of a proof-of-concept experiment using real data provided as raw data to several machine learning platforms. The raw data included production line data (measurements and meta data) from three consecutive stations along the production line. The machine learning platforms were set to predict the outcome (pass/fail of the manufactured product) at the end of the manufacturing line. The comparison was run for several different products having different levels of data imbalance, and the level of accuracy was measured as the percentage of correct predictions—as denoted by the points on the graph in FIG. 4. As indicated in the graph, at high data imbalance (e.g., >95%), only disclosed systems 100 and methods 200 provide sufficient classification accuracy (e.g., >85%) that allows for effective anomaly detection. In contrast, prior art methods (e.g., using algorithms by H2O, Google AutoML and DataRobot) do not reach sufficiently high accuracy at the high range of data imbalance.

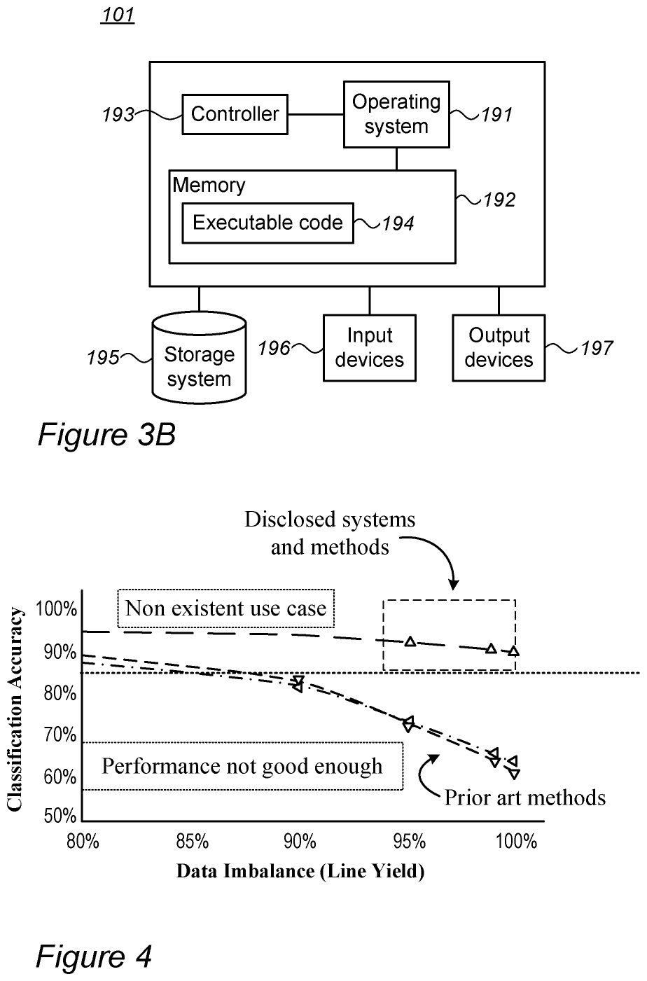

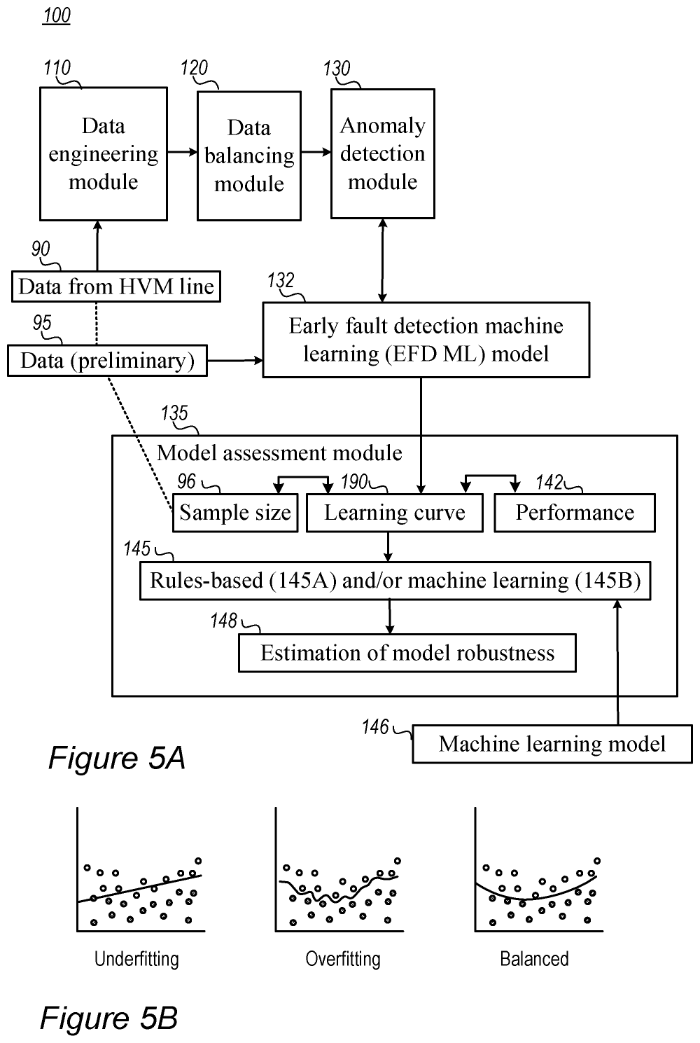

FIG. 5A is a high-level schematic block diagram of a system 100, according to some embodiments of the invention. System 100 improves a high-volume manufacturing (HVM) line that has a high test pass ratio (e.g., 90% or more), and comprises data engineering module 110 configured to receive raw data 90 from the HVM line and derive process variables therefrom, data balancing module 120 configured to generate balanced data from raw data 90 received by data engineering module 110, and anomaly detection module 130 configured to run an early fault detection machine learning (EFD ML) model 132 configured to detect anomalies in the HVM line. For example, EFD ML model 132 may comprise a GNAS (genetic neural architecture search) trained network generated by anomaly detection module 130 as described herein. In other examples, EFD ML model 132 may comprise any type of model, e.g., various neural networks (NN) models, including preliminary stages in the construction of the GNAS trained networks described therein. However, disclosed performance determination through extrapolation of learning curves is not limited to any specific type of EFD ML model 132. As described below, system 100 may further comprise a model assessment module 135 configured to assess the robustness and performance of EFD ML model 132, and possibly enhance and/or optimize the robustness and performance of EFD ML model 132—at a preparatory stage and/or during operation of anomaly detection module 130. It is noted that model assessment module 135 disclosed herein may be used to assess any type of EFD ML model 132, specifically models based on balanced or unbalanced data.

Model assessment module 135 (and related methods 300 disclosed below) may be configured to assess robustness and performance of EFD ML model 132, before and/or during operation of system 100, by constructing a learning curve 190 from a received amount of data from the HVM line 95. Data 95 may be collected in a preparatory stage to construct EFD ML model 132 and/or comprise at least part of data 90 collected during initial running of system 100, and possibly modified as disclosed above by data engineering module 110. In certain embodiments, model assessment module 135 may be used during operation of anomaly detection module 130, using at least part of raw data 90 from the HVM line, to optimize anomaly detection module 130 during operation thereof. It is noted that model assessment module 135 (and related methods 300 disclosed below) may be configured to handle various types of data, including balanced as well as unbalanced data. When preliminary data 95 is balanced, model assessment module 135 may directly use preliminary data 95. When preliminary data 95 is unbalanced, model assessment module 135 may directly use preliminary data 95, or preliminary data 95 may first be at least partly balanced, e.g., by data balancing module 120 and/or model assessment module 135.

Learning curve 190 typically represents a relation between a performance 142 of EFD ML model 132 and a sample size 96 of data 95 on which EFD ML model 132 is based. Model assessment module 135 may be further configured to derive from learning curve 190 an estimation of model robustness 148 by (i) fitting learning curve 190 to a power law function and (ii) estimating a tightness of the fitting (145A) and/or by (iii) applying a machine learning algorithm (e.g., a recurrent neural network) that is trained on a given plurality of learning curves and related normalized performance values (145B), as disclosed in more details below.

Advantageously, model assessment module 135 and methods 300 may be used to enhance and/or optimize the robustness and performance of EFD ML model 132. While EFD ML model 132 provides an automated machine learning pipeline for training, selection, deployment and monitoring of machine learning models tailored for EFD on high-volume digital electronics manufacturing production lines, the data generated for this use case is normally in limited supply and suffers from severe class imbalance, as a result of manufacturers not wanting to produce high quantities with unclassified faults and of the fact that fault occurrences are rare. As a result, data 95 available for construction of EFD ML model 132 is typically provided at small amount 96 and often at a low quality. As a consequence, constructing EFD ML model 132 is very challenging because the model performance is dependent on the quality and quantity of data that it is trained on. With minimal amounts of good quality data, it is difficult to perform the necessary data transformations and engineering of new features that improve the model's performance and reliability. It is therefore crucial to maximize use of the available data and also to estimate the resulting robustness and performance of derived EFD ML model 132. Advantageously, model assessment module 135 and methods 300 may be used without domain-specific knowledge, as they assess the learning curves of the respective models, which are more generic than the models themselves.

FIG. 5B illustrates in a high-level schematic manner some of the challenges involved in constructing EFD ML model 132, as known in the art. Generally, once a machine learning model is built and tested using training data, it is difficult to know with certainty that the model is robust and that what the model has learnt from its training actually captures a pattern in reality. Typical cases of models that do not capture real patterns include overfitting models (which learn the training data too closely) and underfitting models (which do not learn the training data enough), illustrated schematically in FIG. 5B, in comparison to balanced models that can be used as representing reality.

Disclosed model assessment modules 135 and methods 300 are configured to assess the performance of EFD ML model 132 on a minimal amount of less-than-optimal data and to diagnose the performance of EFD ML model 132 in terms of its readiness for production. Moreover, model assessment modules 135 may be configured to extrapolate the assessment of the performance and reliability of EFD ML model 132 to provide the ability to relate the model performance to the amount and quality of data 95 provided by the users of the HVM production line to optimize data 95 (e.g., add data or improve its quality) and to reliably adjust performance expectations. For example, model assessment module 135 may be used to optimize the relation between the amount and quality of data 95 and the robustness and performance of EFD ML model 132 to derive the sufficient but not excessive amount and quality of required data 95, and thereby optimize the construction and use of EFD ML model 132.

It is noted that model assessment module 135 and related methods 300 provide improvements to the technical field of machine learning, and specifically to field of machine learning models for anomaly detection at production lines, e.g., by estimating and/or optimizing the amount and quality of required data and providing optimized model construction methods. By evaluating and providing optimized EFD ML models 132, disclosed modules 135 and methods 300 also optimize the computing resources dedicated to constructing and to operating EFD ML models 132, which enhancing their robustness and minimizing the data processing burden on the respective computing resources. Moreover, disclosed modules 135 and methods 300 yield a more efficient use of provided data 95 and can even indicate the extent to which the use of data is efficient, and improve use efficiency further. Disclosed model assessment module 135 and related methods 300 enable users to estimate if the provided amount and quality of data are sufficient and not superfluous to efficient and robust operation of EFD ML models 132—for example, users may use disclosed modules 135 and methods 300 to detect overfitting or underfitting of EFD ML models 132 which may lead to insufficient performance or to unnecessary data supply burden. Moreover, by optimizing the performance of EFD ML models 132, the overall efficiency of system 100 in improving HVM lines by early fault detection is also enhanced, yielding an increased efficiency of the HVM lines. Due to the complexity of EFD ML models 132 and their construction, disclosed model assessment module 135 and related methods 300 are inextricably linked to computer-specific problems and their solution.

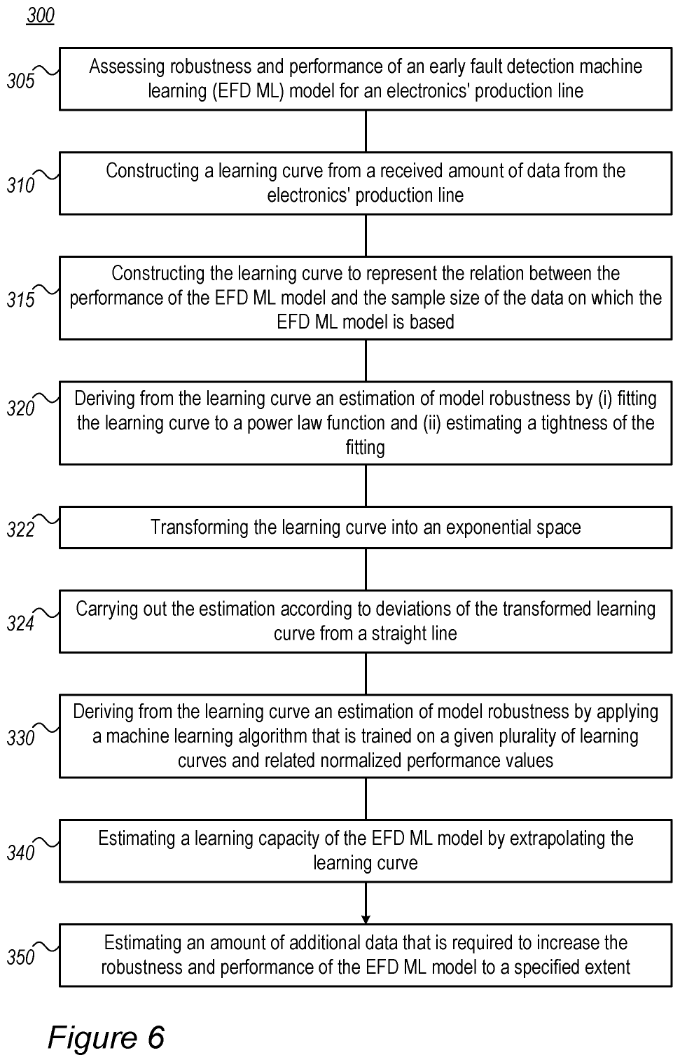

FIG. 6 is a high-level flowchart illustrating methods 300 of assessing robustness and performance of early fault detection machine learning (EFD ML) models for an electronics' production line, according to some embodiments of the invention. The method stages may be carried out with respect to system 100 described above, e.g., by model assessment module 135, which may optionally be configured to implement methods 300. Methods 300 may be at least partially implemented by at least one computer processor, e.g., in model assessment module 135. Certain embodiments comprise computer program products comprising a computer readable storage medium having computer readable program embodied therewith and configured to carried out the relevant stages of methods 300. Methods 300 may comprise the following stages, irrespective of their order.

Methods 300 may comprise assessing robustness and performance of early fault detection machine learning (EFD ML) models for an electronics' production line (stage 305) by constructing a learning curve from a received amount of data from the electronics' production line (stage 310). The learning curve may be constructed to represent a relation between a performance of the EFD ML model and a sample size of the data on which the EFD ML model is based (stage 315).

Methods 300 may further comprise deriving from the learning curve an estimation of model robustness by (i) fitting the learning curve to a power law function and (ii) estimating a tightness of the fitting (stage 320). For example, deriving the estimation of model robustness 320 may be carried out by transforming the learning curve into an exponential space (stage 322), and carrying out the estimation according to deviations of the transformed learning curve from a straight line (stage 324).

Alternatively or complementarily, methods 300 may further comprise deriving from the learning curve an estimation of model robustness by applying a machine learning algorithm (e.g., a recurrent neural network) that is trained on a given plurality of learning curves and related normalized performance values (stage 330).

In various embodiments, methods 300 may further comprise estimating a learning capacity of the EFD ML model by extrapolating the learning curve (stage 340). In various embodiments, methods 300 may further comprise estimating an amount of additional data that is required to increase the robustness and performance of the EFD ML model to a specified extent (stage 350).

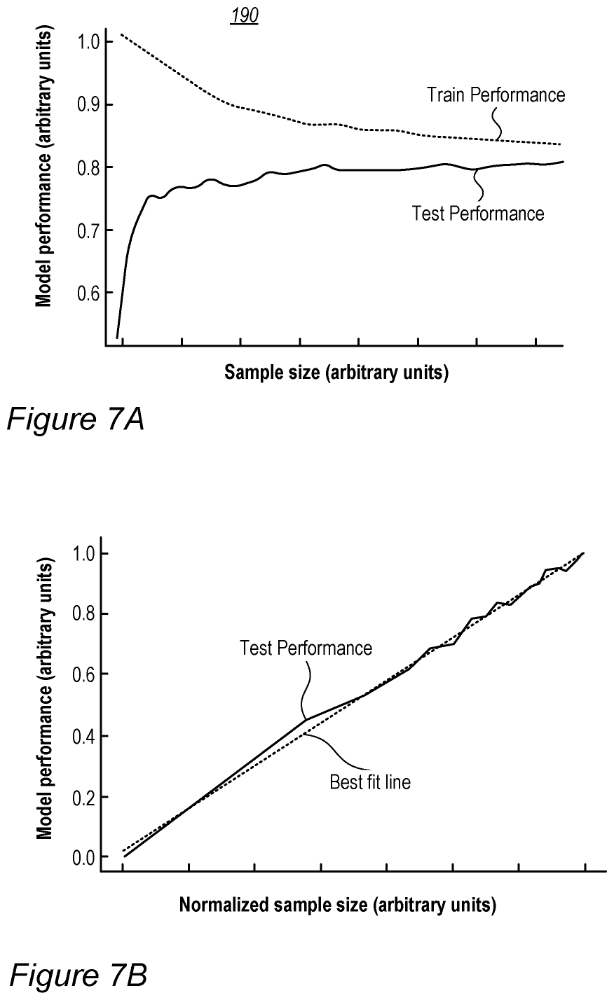

FIG. 7A provides a non-limiting example of learning curve 190, according to some embodiments of the invention. In various embodiments, learning curves 190 comprise plots of training performance and testing performance 142 against sample size 96. Model assessment module 135 and/or related methods 300 may apply analysis of the behavior of learning curves 190 to provide insight into the robustness and production readiness of EFD ML models 132 as well as reasonable estimations of the changes in the performance of EFD ML models 132 upon increasing of sample size 96.

Learning curves use cross-validation to find the most realistic performance of a model at different sizes of sample data. Each cross-validation score for a given sample size is derived by averaging model performance on a part of the sample data, for a model that was trained on another part of the data, over different partitions of the sample data. The model performance may then be evaluated with respect to the size of the sample data by plotting the average of the cross-validation scores of the model against the increasing size of the sample data. As illustrated by the non-limiting example of FIG. 7A, as sample size 96 increases, the train performance decreases while the test performance increases. In accordance with empirical analysis, as the sample size for training a model increases, learning curve 190 (relating the model performance to the sample size) follows a power law that closely resembles a logarithm, e.g., the testing accuracy increases as the model begins to learn, and as the model learns, the rate of learning decreases until the model has learnt all it can from the training data and the curve tails off. A non-limiting example for calculating the cross-validation scores and deriving learning curve 190 includes splitting data 95 into samples with different sizes 96, for each sample size calculating and then averaging the model performance for multiple splits of the sample into training and testing data, and constructing learning curve 190 from the average performance 142 compared with respective sample sizes 96.

In certain embodiments, model assessment module 135 may be further configured to derive the estimation of the model robustness by transforming learning curve 190 into an exponential space and carrying out the estimation according to deviations of the transformed learning curve from a straight line, or, in different terms, fitting learning curve 190 to a power law function (e.g., y=ax^{b}+ϵ) and estimating a tightness of the fitting 145A. Model assessment module 135 may be configured to use knowledge about model performance and robustness to define a rules based algorithm and classify the relationship between a model at its training data size as, e.g., robust, not learning or deteriorating with more data—according to specified rules. Model assessment module 135 may be configured to apply specific expertise to either prescribe a solution or diagnose a problem with the model, and to extrapolate performance of particularly classified curves, and return whether a reasonable amount of additional data would improve the model and by how much. As illustrated by the non-limiting example of FIG. 7B, observed test performance at different sample sizes, transformed into the exponential space by the fitted power law function, may be used by model assessment module 135 to evaluate the performance of the model by comparing it to a straight line (denoted “best fit line”) in the corresponding exponential space. For example, using the gradient of the transformed curve and finding the root-mean-square error (RMSE) and r² of the best fit line in the transformed space, the performance of the model may be evaluated and the appropriate diagnoses may be made. In non-limiting examples, learning curve 190 may be classified as robust upon comparison to a fitted straight line in exponential space, using the flatness of the transformed curve to indicate the ideal learning rate and further evaluating the extent to which training data is representative by determining with the RMSE and r² scores of the transformed curve when compared with the fitted line. Specifically, the sign of the fitted line may be used to indicate whether the model is learning or deteriorating with additional data. The magnitude of the fitted line's gradient indicates the learning rate of the model. Model assessment module 135 may be configured to apply empirical analysis to calibrate a robustness score from, e.g., RMSE and/or r² score and the gradient of the best fitting line and classify learning curve 190 accordingly.

Model assessment module 135 may be further configured to derive from learning curve 190 an estimation of model robustness 148 by applying a machine learning algorithm (e.g., a recurrent neural network) that is trained on a given plurality of learning curves and related normalized performance values 145B, as disclosed in more details below. In certain embodiments, multiple learning curves 190 may be generated and labeled in advance (manually and/or automatically) with respect to their robustness status and learnability (improvement or decline in performance with more data), for example using splits of a given data set and/or past data sets. Alternatively or complementarily, accumulating real data 90 may be used to augment data 95, to derive more learning curves 190 and enhance the extent to which model assessment module 135 evaluates learning curves 190. For example, an additional machine learning model 146 (shown schematically in FIG. 5A) may be configured to classify learning curve 190 as, e.g., either robust, not learning or deteriorating and/or as having learning capacity or not having learning capacity. In certain embodiments, machine learning model 146 may be used to generate a list relating normalized performance values of the learning curves (e.g., normalized to account for differing data sample sizes) with corresponding labels of the statuses of the learning curves as disclosed herein. For example, machine learning model 146 may implement recurrent neural network(s) to first classify the robustness status of the learning curves and if robust, classify the learning capacity of the learning curves. Learning curves that are classified as robust and with learning capacity may be extrapolated to estimate the model's performance with more data. Advantageously, the machine learning approach allows to add more labelled samples (manually and/or automatically) to improve the performance of machine learning model 146 and/or the thresholds of machine learning model 146 may be calibrated and specific metric may be compared to derive the most effective metric(s) for evaluating learning curves 190.

In certain embodiments, disclosed rule-based 145A and machine learning 145B approaches may be combined, e.g., applied to different cases. For example, rule-based approach 145A may be applied at an initial phase until sufficient information is gathered concerning learning curves 190 and their related statuses, and then machine learning approach 145B may be applied to further generalize and improve the evaluations for consecutive learning curves 190. Alternatively or complementarily, rule-based 145A and machine learning 145B approaches may be applied and compared in parallel, and updated according to accumulating learning curves 190 and respective evaluations.

In certain embodiments, model assessment module 135 may be further configured to estimate a learning capacity of EFD ML model 132 by extrapolating learning curve 190. For example, learning curves that are diagnosed as robust may then be evaluated for their learning capacity at a given amount of provided input data. Learning capacity may be determined, e.g., by computing the derivative of learning curve 190 at the given amount of provided input data. In case learning curve 190 is judged to be robust and has sufficient learning capacity, the fitted power law curve can be extrapolated to understand how much the model can be improved by providing more data (within a reasonable range). In certain embodiments, model assessment module 135 may be further configured to estimate an amount of additional data that is required to increase in the robustness and performance of EFD ML model 132 to a specified extent.

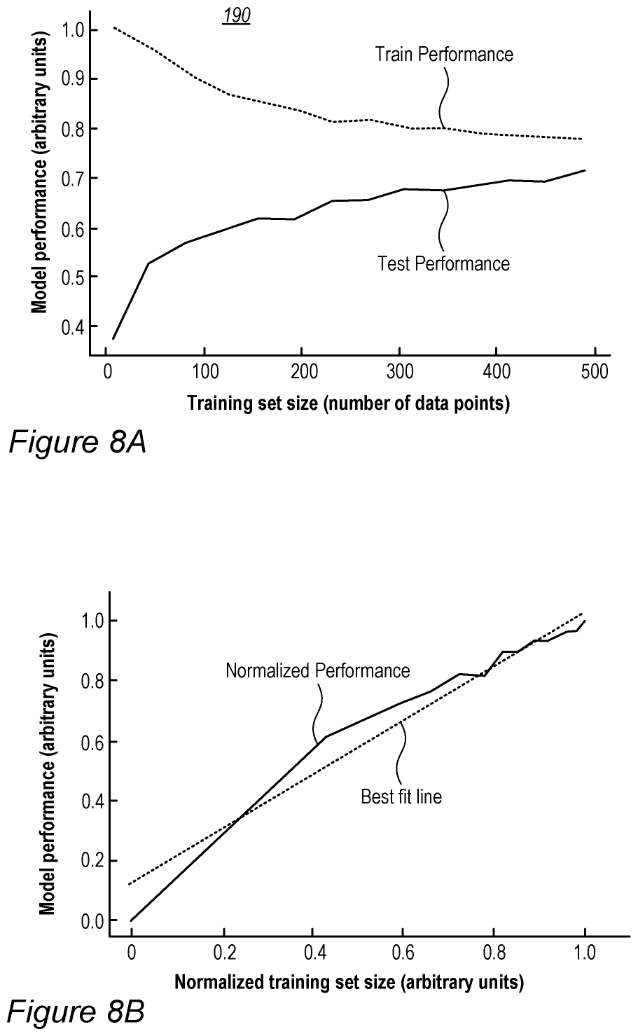

FIGS. 8A and 8B provide a non-limiting example of learning curve 190 for fully trained robust model 132, according to some embodiments of the invention. FIG. 8A illustrates respective learning curve 190 and FIG. 8B illustrates the test performance as evaluated in the normalized exponential space; the normalized transformed curve has a low RMSE, a high r² score and a strong gradient when compared to its best fine straight line, and can therefore be classified as robust. Extrapolating the curve shows that the model has low learnability and probably cannot be further improved. This is because the curve becomes flat (has a derivative that approaches zero) around the 0.7 value and therefore increasing the sample size would not yield much increase in the model performance.

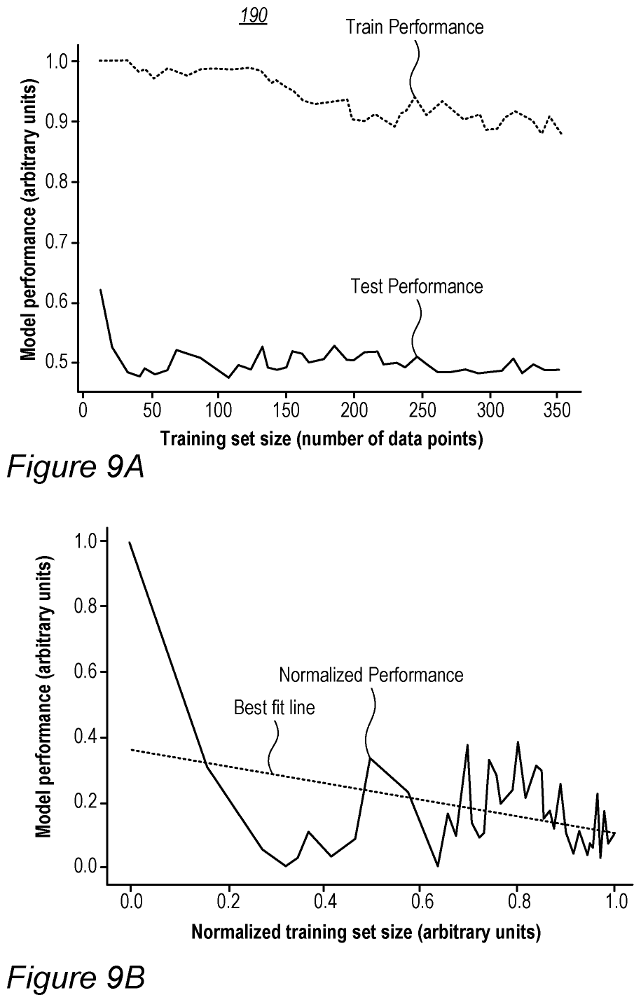

FIGS. 9A and 9B provide a non-limiting example of learning curve 190 for fully trained deteriorating model 132, according to some embodiments of the invention. FIG. 9A illustrates respective learning curve 190 and FIG. 9B illustrates the test performance as evaluated in the normalized exponential space; the negative gradient may be used to automatically classify respective model 132 as deteriorating and no estimations for further improvements are made. Additionally, FIG. 9B indicates that the respective model is not stable.

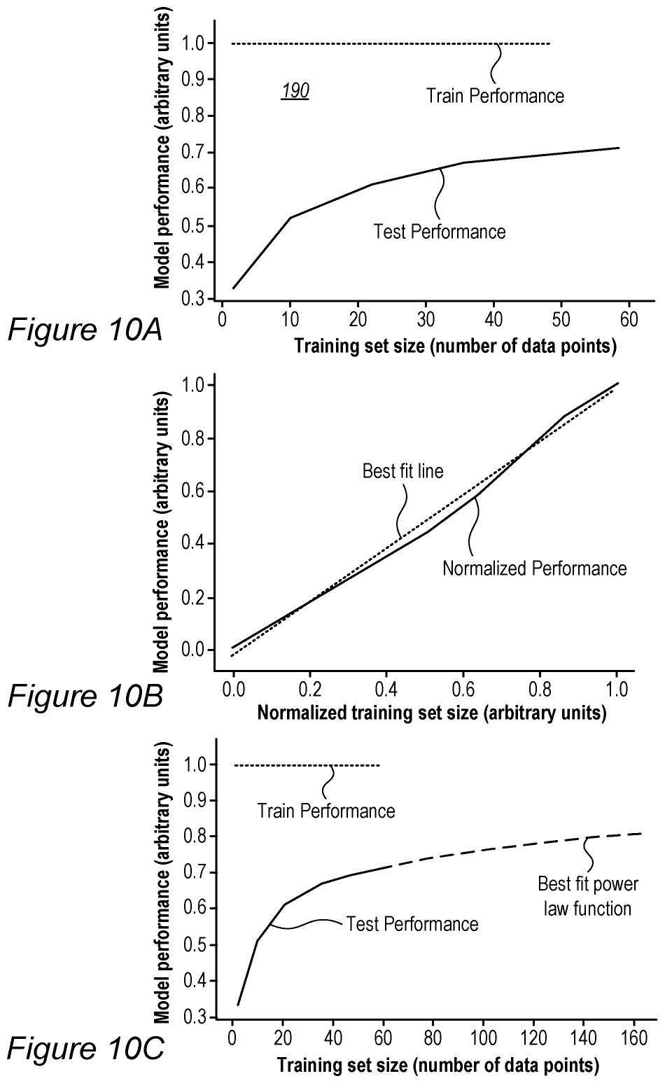

FIGS. 10A, 10B and 10C provide a non-limiting example of learning curve 190 for model 132 with a high learning capacity, according to some embodiments of the invention. FIG. 10A illustrates respective learning curve 190 and FIG. 10B illustrates the test performance as evaluated in the normalized exponential space; the extrapolations show that model 132 has high learnability and estimations for further improvements may be made—as illustrated schematically in FIG. 10C, the derived power law function (as indicated by the extrapolated broken line) suggests that the model would improve if additional data is added (e.g., from 0.7 to 0.8 by adding ca. 100 data points in the illustrated schematic example).

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof. It is noted that processors mentioned herein may comprise any type of processor (e.g., one or more central processing unit processor(s), CPU, one or more graphics processing unit(s), GPU or general purpose GPU—GPGPU, etc.), and that computers mentioned herein may include remote computing services such as cloud computers to partly or fully implement the respective computer program instructions, in association with corresponding communication links.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or portions thereof. The computer program instructions may take any form of executable code, e.g., an application, a program, a process, task or script etc., and may be integrated in the HVM line in any operable way.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A system for improving a high-volume manufacturing (HVM) line that has a test pass ratio of at least 90%, the system comprising:
a data engineering module configured to receive raw data from the HVM line and derive process variables therefrom,
a data balancing module configured to generate balanced data from the raw data received by the data engineering module, and
an anomaly detection module comprising a GNAS (genetic neural architecture search) network comprising an input layer including the balanced data generated by the data balancing module and a plurality of interconnected layers, wherein each interconnected layer comprises:
a plurality of blocks, wherein each block comprises a model that applies specified operations to input from the previous layer in relation to the derived process variables—to provide an output to the consecutive layer and a fitness estimator of the model,
a selector sub-module configured to compare the models of the blocks using the respective fitness estimators, and
a mutator sub-module configured to derive an operation probability function relating to the operations and a model probability function relating to the models —which are provided as input to the consecutive layer;
wherein the model outputs, the operation probability function and the model probability function provided by the last of the interconnected layers are used to detect anomalies in the HVM line at a detection rate of at least 85%.

2. The system of claim 1, wherein the data engineering module is further configured to adjust the raw data for processing by the data balancing module and the anomaly detection module.

3. The system of claim 1, wherein the data balancing module is further configured to generate the balanced data by separating pass from fail results in the raw data and enhancing under-represented fail data.

4. The system of claim 3, wherein the data balancing module is further configured to enhance under-represented fail data by:
identifying specific electronic components or circuits by fitting the raw data to known physical models thereof,
deriving data points corresponding to characteristic failure behavior of the identified specific electronic components or circuits, and
adding the derived data points to yield the balanced data.

5. The system of claim 4, wherein the data balancing module is further configured to derive the data points corresponding to characteristic failure behavior of the identified specific electronic components or circuits—at least partly from the raw data.

6. The system of claim 1, wherein the mutator sub-module is further configured to modify the blocks and/or the layer structure according to results of the comparison of the blocks in the previous layer by the selector sub-module.

7. A method of improving a high-volume manufacturing (HVM) line that has a test pass ratio of at least 90%, the method comprising:
receiving raw data from the HVM line and deriving process variables therefrom,
generating balanced data from the received raw data, and
detecting anomalies relating to the HVM line by constructing a GNAS (genetic neural architecture search) network that includes an input layer including the generated balanced data and a plurality of interconnected layers, wherein the constructing of the GNAS network comprises:
arranging a plurality of blocks for each interconnected layer, wherein each block comprises a model that applies specified operations to input from the previous layer in relation to the derived process variables—to provide an output to the consecutive layer and a fitness estimator of the model,
comparing the models of the blocks using the respective fitness estimators, and
deriving an operation probability function relating to the operations and a model probability function relating to the models by mutating the blocks and the structure of the layers, and providing the model outputs, the operation probability function and the model probability function as input to the consecutive layer;
wherein the model outputs, the operation probability function and the model probability function provided by the last of the interconnected layers are used to detect anomalies in the HVM line at a detection rate of at least 85%.

8. The method of claim 7, further comprising adjusting the received raw data for the anomaly detection.

9. The method of claim 7, wherein the generating of the balanced data comprises separating pass from fail results in the received raw data and enhancing under-represented fail data.

10. The method of claim 9, wherein the enhancing of under-represented fail data is carried out by:
identifying specific electronic components or circuits by fitting the raw data to known physical models thereof,
deriving data points corresponding to characteristic failure behavior of the identified specific electronic components or circuits, and
adding the derived data points to yield the balanced data.

11. The method of claim 10, wherein the deriving of the data points corresponding to characteristic failure behavior of the identified specific electronic components or circuits—is carried out at least partly from the raw data.

12. The method of claim 7, further comprising carrying out the mutating of the blocks and of the structure of the layers according to the comparison of the blocks, by modifying the blocks and/or the layer structure according to results of the comparison of the blocks in the previous layer.

13. The method of claim 7, wherein at least one of: the receiving, generating and detecting is carried out by at least one computer processor.

14. A computer program product for improving a high-volume manufacturing (HVM) line that has a test pass ratio of at least 90%, the computer program product comprising a non-transitory computer readable storage medium having computer readable program embodied therewith, the computer readable program comprising:
computer readable program configured to receive raw data from the HVM line and derive process variables therefrom,
computer readable program configured to generate balanced data from the received raw data, and
computer readable program configured to detect anomalies relating to the HVM line by constructing a GNAS (genetic neural architecture search) network that includes an input layer including the generated balanced data and a plurality of interconnected layers, wherein the constructing of the GNAS network comprises:
arranging a plurality of blocks for each interconnected layer, wherein each block comprises a model that applies specified operations to input from the previous layer in relation to the derived process variables—to provide an output to the consecutive layer and a fitness estimator of the model,
comparing the models of the blocks using the respective fitness estimators, and
deriving an operation probability function relating to the operations and a model probability function relating to the models by mutating the blocks and the structure of the layers, and providing the model outputs, the operation probability function and the model probability function as input to the consecutive layer;
wherein the model outputs, the operation probability function and the model probability function provided by the last of the interconnected layers are used to detect anomalies in the HVM line at a detection rate of at least 85%.

15. The computer program product of claim 14, further comprising computer readable program configured to adjust the received raw data for the anomaly detection.

16. The computer program product of claim 14, wherein the computer readable program for generating of the balanced data further comprises computer readable program configured to separate pass from fail results in the received raw data and enhance under-represented fail data.

17. The computer program product of claim 16, wherein the computer readable program for enhancing of under-represented fail data further comprises:
computer readable program configured to identify specific electronic components or circuits by fitting the raw data to known physical models thereof,
computer readable program configured to derive data points corresponding to characteristic failure behavior of the identified specific electronic components or circuits, and
computer readable program configured to add the derived data points to yield the balanced data.

18. The computer program product of claim 14, further comprising computer readable program configured to carry out the mutating of the blocks and of the structure of the layers according to the comparison of the blocks, by modifying the blocks and/or the layer structure according to results of the comparison of the blocks in the previous layer.
